(19) United States
(12) Patent Application Publication
(10) Pub. No.: US 2010/0310685 A1
(43) Pub. Date: Dec. 9, 2010

(54) PUPICIDAL AND LARVICIDAL COMPOSITION

(76) Inventor: Mario Antonello Principato, Perugia (IT)

Correspondence Address: Modiano & Associati, Via Meravigli 16, Milano, 20123, IT

(21) Appl. No.: 12/735,538

(22) PCT Filed: Feb. 5, 2008
(86) PCT No.: PCT/EP2008/051372

§ 371 Date: Jul. 26, 2010

(51) Int. Cl. A01N 31/02; A01N 65/22; A01N 37/40; A01P 7/04

(52) U.S. Cl. 424/747; 514/724; 514/159

(57) ABSTRACT

A pupicidal and larvicidal composition which comprises, predominantly and in proportions which can vary from approximately 0% to approximately 100%, cetyl alcohol, and wherein the rest of the composition, where necessary, is also constituted by at least one excipient.

The present invention relates to a pupicidal and larvicidal composition suitable to be placed in environments frequented by human beings and by confined or nonconfined domestic and nondomestic animals and particularly suitable for eliminating the juvenile stages of mosquitoes.

### BACKGROUND OF THE INVENTION

The generic term “mosquitoes” is used to reference a very large number of insects belonging to the order Diptera, suborder Nematocera, family Culicidae. This family comprises 35 genera and as many as 2700 species.

The larvae are always aquatic, while the adults are winged and subaerial. The buccal apparatus is of the lapping type in males, which feed on plant essences, and of the piercing-sucking type in females, which in many species are hematophagous, i.e., they feed on blood.

In species which lay eggs in water, the mosquito lands on the surface of the water (which accordingly must be still) to lay approximately up to 500 eggs. An elongated, legless and bristle-covered larva emerges from the eggs and lives exclusively underwater, moving toward the surface to breathe by means of a siphon (e.g., the Culex and Aedes genera) or a spiracle (e.g. Anopheles genus) arranged in the terminal part (abdomen) of the body. The larvae feed on zooplankton, which they convey toward their mouth by way of the circular motions of their buccal bristles. Mosquitoes all have 4 larval stages.

After a period which varies from a few days to a few weeks, depending on the temperature, they progress to the pupa stage. Pupae live stably close to the surface of the water in order to take oxygen from the air with two structures located close to their head. An exception is constituted by Mansonia richardii pupae, which live constantly submerged and obtain oxygen from aquatic plants by virtue of a modified siphon which is driven into in the aerenchyma of plants.

Most existing insecticides are based on active ingredients which are unquestionably effective but are characterized by specific degrees of toxicity for human beings and animals as well.

The elimination of mosquito larvae and pupae therefore entails a heavy risk of intoxication for fish and other inhabitants of bodies of water in which the insecticidal products are distributed, and problems can also occur for human beings who use said water for various purposes (for example irrigation).

### SUMMARY OF THE INVENTION

The aim of the present invention is to provide a pupicidal and larvicidal composition which has a substantially negligible toxicity for animals, particularly fish, and for human beings.

Within this aim, an object of the present invention is to provide a pupicidal and larvicidal composition which has a low cost, is relatively simple to provide in practice, and is safe in application.

This aim and this and other objects which will become better apparent hereinafter are achieved by a pupicidal and larvicidal composition, characterized in that it comprises, predominantly and in proportions which can vary from approximately 0% to approximately 100%, cetyl alcohol, and wherein the rest of the composition, where necessary, is also constituted by at least one excipient.

### DESCRIPTION OF THE PREFERRED EMBODIMENTS

The formulations of pupicidal and/or larvicidal compositions according to the invention are intended to suppress diptera, particularly the entire group of arthropods generally termed “mosquitoes”, by means of active ingredients and excipients which have low toxicity.

The percentage in mass, in the formulation of a composition according to the invention, of the cited active ingredient is therefore comprised between 0% and 100%; the rest of the composition, where necessary, is optionally constituted by at least one excipient or other active ingredients which have a synergistic or complementary effect with respect to the main one. It should be noted that depending on the percentage by weight with which it occurs within a specific formulation, a same substance can act equally as an active ingredient or as an excipient.

The composition according to the invention comprises predominantly (in that other active ingredients, which perform synergistic or complementary actions with respect to the one defined hereafter, may also be present), and in proportions which can vary from approximately 0% to approximately 100%, cetyl alcohol and wherein the rest of the composition, where necessary, is constituted also by at least one excipient.

Cetyl alcohol, more specifically termed 1-hexadecanol, is an alcohol contained in lipids, generally derived from coconut oil. It is an emulsifier used generally as an adjuvant in the stabilization of certain products. At ambient temperature it has the appearance of a waxy solid which can vary from colorless to white and is odorless.

The composition according to the invention may also comprise essential oils: in particular, one embodiment which has optimum effectiveness in suppressing larvae and pupae of mosquitoes comprises essential oil of peppermint. Said essential oil ensures the formation of a film, on the free surface of the water in which the product is distributed (ponds, lakes or natural or artificial bodies of water of any other kind and/or size); this film of infinitesimal thickness ensures contact of the larvae and/or pupae with the compound.

According to another equally effective embodiment, the composition comprises salicylic acid.

From a practical standpoint, it must be stressed that cetyl alcohol is a substance of the solid type at ambient temperature (waxy consistency): in order to allow its combination in solution with any other active ingredients and/or suitable excipients, it is liquefied. This liquefaction occurs following heating of the cetyl alcohol.

Likewise, salicylic acid also is a substance of the solid type at ambient temperature and liquefaction for dissolving occurs, in this case also, by heating it.

One of the possible excipients is a sorbitan monolaurate of polyoxyethylene, a product known commercially as Tween.

According to another possible embodiment, one possible excipient is water.

From a practical point of view, some of the possible embodiments in application related to specific formulations of undisputed effectiveness and with negligible/nil toxicity are cited hereafter.

Among the following formulations, the amounts involved are to be considered purely to define the proportions among the various components.

First formulation: dissolve 0.5 g of cetyl alcohol in 15 ml of water containing one drop of Tween 20.

By way of example, by pouring 1.4 ml of the solution related to this first formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and the larvae are observed to die in approximately 18 hours.

Second formulation: dissolve with heat 0.4 g of cetyl alcohol in 5 ml of essential oil of peppermint.

By way of example, by pouring 4 drops of the solution related to this second formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and the larvae are observed to die in approximately one hour and a half.

Third formulation: dissolve with heat 0.1 g of cetyl alcohol in 5 ml of essential oil of peppermint.

By way of example, by pouring 4 drops of the solution related to this third formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and a half and the larvae are observed to die in approximately two hours.

Fourth formulation: dissolve with heat 0.3 g of cetyl alcohol in 5 ml of essential oil of peppermint.

By way of example, by pouring 4 drops of the solution related to this fourth formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and a half and the larvae are observed to die in approximately two hours.

Fifth formulation: dissolve with heat 0.5 g of cetyl alcohol in 5 ml of essential oil of peppermint.

By way of example, by pouring 4 drops of the solution related to this fifth formulation (taking care to choose a solution thereof which is pre-diluted in 20 ml of water) into a tray (15 cm wide, 15 cm long and 6.5 cm deep) which contains 1 l of water which contains mosquito larvae and pupae, all the larvae are observed to die approximately in one hour and 90% of the pupae are observed to die in approximately two hours.

For all the formulations from the second to the fifth, it is essential that during the pre-dilution step, before use, the composition is shaken vigorously so that it emulsifies in an optimum manner with the water. These formulations can then be poured or more appropriately atomized at the edges of areas where water stagnates.

Sixth formulation: dissolve with heat 0.5 g of cetyl alcohol and 0.5 g of salicylic acid in 5 ml of essential oil of peppermint.

By way of example, by pouring 4 drops of the solution related to this sixth formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and the larvae are observed to die in approximately 15 minutes.

Seventh formulation: dissolve with heat 0.6 g of cetyl alcohol and 0.5 g of salicylic acid in 5 ml of essential oil of peppermint.

By way of example, by pouring 4 drops of the solution related to this seventh formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and the larvae are observed to die in approximately 20 minutes.

Eighth formulation: dissolve with heat 0.6 g of cetyl alcohol and 0.6 g of salicylic acid in 5 ml of essential oil of peppermint.

By way of example, by pouring 4 drops of the solution related to this eighth formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and the larvae are observed to die in approximately 30 minutes.

Ninth formulation: dissolve with heat 0.8 g of cetyl alcohol and 0.5 g of salicylic acid in 5 ml of essential oil of peppermint.

By way of example, by pouring 4 drops of the solution related to this ninth formulation (taking care to choose a solution thereof which is pre-diluted in 20 ml of water) into a tray (15 cm wide, 15 cm long and 6.5 cm deep) which contains 1 l of water which contains mosquito larvae and pupae, the pupae are observed to die approximately in one hour and the larvae are observed to die in approximately 30 minutes.

As regards the formulations from the sixth to the ninth, it must be specified that all the possible formulations in which 0.3 to 0.7 g of cetyl alcohol and 0.5 to 0.6 g of salicylic acid (dissolved with heat in 5 ml of essential oil of peppermint) and 0.1 to 0.4 g of cetyl alcohol in 5 ml of essential oil of peppermint are present, lead to optimum results which have already been verified appropriately in the laboratory. Any extensions of the ranges within which the cetyl alcohol and/or the salicylic acid can vary within the essential oil, of peppermint in particular, fall within the protective scope of the present application although they are not specifically described, since they are the subject of what is claimed.

Other excipients which can be introduced conveniently in a composition according to the invention are citral, borneol, cineol and geraniol in any shape or form thereof, particularly as essential oils.

Likewise, other possible excipients can be glycerin, propylene glycol, stearyl alcohol and/or lauryl alcohol.

From a functional standpoint, it must be specified that specific research that has been conducted shows that cetyl alcohol is an excellent pupicide (it kills pupae) of Nematocera Diptera (for example mosquitoes).

Likewise, it has been found that the essential oil of peppermint is an excellent larvicide (it kills larvae) of Nematocera diptera, the effect of which may also be augmented by use in combination with salicylic acid.

By way of example, with an exemplifying quantity of approximately 100 ml of one of the formulations from the second to the ninth described earlier it is possible to perform disinfestation of an area of approximately 150 m².

With an exemplifying quantity of approximately 1.4 l of the first formulation described earlier, it is possible to perform disinfestation of an area of approximately 150 m².

It has thus been found that the invention achieves the intended aim and object.

The invention thus conceived is susceptible of numerous modifications and variations, all of which are within the scope of the appended claims.

All the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and the dimensions, may be any according to requirements without thereby abandoning the scope of the protection of the appended claims.

1-10. (canceled)

11. A pupicidal and larvicidal composition, comprising, predominantly and in proportions ranging from approximately 0% to approximately 100%, cetyl alcohol, and wherein the rest of the composition, where necessary, is constituted by at least one excipient.

12. The composition according to claim 11, further comprising essential oils.

13. The composition according to claim 12, further comprising essential oil of peppermint.

14. The composition according to claim 11, further comprising salicylic acid.

15. The composition according to claim 11, wherein said cetyl alcohol is a substance of the solid type at ambient temperature, liquefaction for solution occurring as a consequence of heating it.

16. The composition according to claim 11, wherein said salicylic acid is a substance of the solid type at ambient temperature, liquefaction for solution occurring as a consequence of heating it.

17. The composition according to claim 11, wherein one of said excipients is a polyoxyethylene sorbitan monolaurate, a product known commercially as Tween.

18. The composition according to claim 11, wherein one of said excipients is water.

19. The composition according to claim 11, wherein said excipients comprise stearyl alcohol in a quantity which can vary from 0.01% to 99%.

20. The composition according to claim 11, wherein said excipients comprise lauryl alcohol in a quantity which can vary from 0.01% to 99%.
